(19) United States
(12) Patent Application Publication
(10) Pub. No.: US 2026/0188834 A1
(43) Pub. Date: Jul. 2, 2026

(54) BATTERY PACK WITH VENTING AND LOAD-BEARING CAPABILITIES

(71) Applicant: Wisk Aero LLC, Mountain View, CA (US)

(72) Inventors: Anthony Courville, Mountain View, CA (US); Joshua Bender, San Jose, CA (US); Sytse Tacoma, Christchurch (NZ)

(73) Assignee: Wisk Aero LLC, Mountain View, CA (US)

(21) Appl. No.: 19/340,638

(22) Filed: Sep. 25, 2025

Related U.S. Application Data
(60) Provisional application No. 63/739,856, filed on Dec. 30, 2024.
(60) Provisional application No. 63/762,826, filed on Feb. 25, 2025.

(51) Int. Cl. H01M 50/367; H01M 10/613; H01M 10/6568; H01M 50/204; H01M 50/222; H01M 50/233; H01M 50/358

(52) U.S. Cl. CPC H01M 50/367; H01M 10/613; H01M 10/6568; H01M 50/204; H01M 50/222; H01M 50/233; H01M 50/358

(57) ABSTRACT

A battery pack including an enclosure, a plurality of rows of battery modules, where each battery module may include a plurality of battery cells, and a venting system positioned between a first row of battery modules and a second row of battery modules. The venting system is fluidly coupled to the first row and may define a first vent volume from each battery module of the first row to exterior of the battery pack, the venting system is fluidly coupled to the second row and may define a second vent volume from each battery module of the second row of battery modules to exterior of the battery pack, the first vent volume is fluidly isolated from the second vent volume; the venting system is coupled to a surface of the enclosure, and the venting system provides support to, and increases a rigidity of, the battery pack.

### CROSS-REFERENCES TO RELATED APPLICATIONS

This application claims priority to Provisional Ser. No. 63/739,856 , for “Battery Pack With Venting And Load-Bearing Capabilities,” filed on Dec. 30, 2024, and Provisional Ser. No. 63/762,826 , for “Battery Pack With Venting And Load-Bearing Capabilities,” filed on Feb. 25, 2025, each of which are incorporated herein by reference in their entirety for all purposes.

### BACKGROUND

The development of electronics has placed an increasingly large importance on the capabilities of rechargeable batteries. For example, battery packs used in electric vehicles are designed to account for thermal runaway events of one or more battery cells in that battery module. However, there are challenges in designing the battery modules to optimally account for such thermal runaway events.

### SUMMARY

One aspect of the disclosure provides for a battery pack including an enclosure defining an internal volume, a plurality of rows of battery modules positioned in the internal volume, where each battery module may include a plurality of battery cells, and a venting system positioned in the internal volume between a first row of battery modules of the plurality of rows of battery modules and a second row of battery modules of the plurality of rows of battery modules. The venting system is fluidly coupled to the first row of battery modules and may define a first vent volume from each battery module of the first row of battery modules to exterior of the battery pack, the venting system is fluidly coupled to the second row of battery modules and may define a second vent volume from each battery module of the second row of battery modules to exterior of the battery pack, the first vent volume is fluidly isolated from the second vent volume; the venting system is coupled to a surface of the enclosure, and the venting system provides support to, and increases a rigidity of, the battery pack.

Implementations may include one or more of the following features. The venting system may include a divider that may partially define the first vent volume on a first surface of the divider and the second vent volume on a second surface of the divider. The divider may include a coolant manifold fluidly coupled to each battery module of the first row of battery modules and the second row of battery modules. The venting system is a first venting system and the battery pack further may include a platform including a first side and a second side opposite the first side. The first venting system, the first row of battery modules, and the second row of battery modules are coupled to the first side of the platform. The battery pack my further include a second venting system, a third row of battery modules of the plurality of rows of battery modules, and a fourth row of battery modules of the plurality of rows of battery modules are coupled to the second side of the platform, where the second venting system is positioned between the third row of battery modules and the fourth row of battery modules. The second venting system may be fluidly coupled to the third row of battery modules and may define a third vent volume from each battery module of the third row of battery modules to exterior of the battery pack, the second venting system may be fluidly coupled to the fourth row of battery modules and may define a fourth vent volume from each battery module of the fourth row of battery modules to exterior of the battery pack, and the third vent volume may be fluidly isolated from the fourth vent volume. The surface of the enclosure may be a first surface of the enclosure, the first venting system may be coupled between the first surface and the first side of the platform to provide structural support between the first surface and the platform, and the second venting system may be coupled between a second surface of the enclosure and a second side of the platform to provide structural support between the second surface and the platform. The enclosure may define an exit opening to exterior of the battery pack, and the first vent volume, the second vent volume, the third vent volume and the fourth vent volume may be in fluid communication with the exit opening. The battery pack may further include a plurality of panels at least partially defining the enclosure. The surface of the enclosure may be a first surface of a first panel of the plurality of panels and the venting system may be coupled to the first panel to provide support to, and increases the rigidity of, the battery pack. Each panel of the plurality of panels may include a plurality of ribs extending in the internal volume, the first surface of the first panel may include a rib surface of a first rib of the plurality of ribs, and the venting system is coupled to the first rib to provide support to, and increases the rigidity of, the battery pack. Adjacent ribs of the plurality of ribs may define a pocket therebetween, and each battery module of the first row of battery modules and each battery module of the second row of battery modules may be positioned at least partially over a corresponding pocket. The corresponding pocket that each battery module of the first row of battery modules and each battery module of the second row of battery modules is positioned over may be exclusive to each battery module. At least one panel of the plurality of panels may include a carbon fiber material. The battery pack further may include a thermally insulating adhesive adhering the venting system to the first panel. Each battery module of the first row of battery modules and each battery module of the second row of battery modules may be coupled to the surface of the enclosure such that each battery module of the first row of battery modules and each battery module of the second row of battery modules provides support to, and increases the rigidity of, the battery pack. A first battery module of the first row of battery modules may exhaust a first effluent discharge from the first battery module, through the first vent volume, to exterior of the battery pack, and the first effluent discharge within the first vent volume may be fluidly isolated from the second vent volume.

One aspect of the disclosure provides for a battery pack including an enclosure defining an exit opening exposing the battery pack to an environment outside of the battery pack, the pack also may include a plurality of rows of battery modules positioned in the enclosure, where each battery module may include a plurality of battery cells, and a venting system positioned in the enclosure between a first row of battery modules of the plurality of rows of battery modules and a second row of battery modules of the plurality of rows of battery modules. The venting system is fluidly coupled to the first row of battery modules and may define a first vent volume from each battery module of the first row of battery modules to the exit opening, the venting system is fluidly coupled to the second row of battery modules and may define a second vent volume from each battery module of the second row of battery modules to the exit opening, the first vent volume is fluidly isolated from the second vent volume, the venting system is coupled to the enclosure, and the venting system provides support to, and increases a rigidity of, the battery pack.

Implementations may include one or more of the following features. The venting system is a first venting system and the battery pack further may include a platform including a first side and a second side opposite the first side. The first venting system, the first row of battery modules, and the second row of battery modules are coupled to the first side of the platform. The battery pack my further include a second venting system, a third row of battery modules of the plurality of rows of battery modules, and a fourth row of battery modules of the plurality of rows of battery modules are coupled to the second side of the platform, where the second venting system is positioned between the third row of battery modules and the fourth row of battery modules. The battery pack where the venting system is a first venting system; and the battery pack further may include: a platform including a first side and a second side opposite the first side, where the first venting system, the first row of battery modules, and the second row of battery modules are coupled to the first side of the platform; and a second venting system, a third row of battery modules of the plurality of rows of battery modules, and a fourth row of battery modules of the plurality of rows of battery modules are coupled to the second side of the platform, where the second venting system is positioned between the third row of battery modules and the fourth row of battery modules. The second venting system may be fluidly coupled to the third row of battery modules and may define a third vent volume from each battery module of the third row of battery modules to exterior of the battery pack, the second venting system may be fluidly coupled to the fourth row of battery modules and may define a fourth vent volume from each battery module of the fourth row of battery modules to exterior of the battery pack, and the third vent volume may be fluidly isolated from the fourth vent volume. The battery pack may further include a plurality of panels at least partially defining the enclosure. The venting system is coupled may be a first panel to provide support to, and increases the rigidity of, the battery pack.

One aspect of the disclosure provides for a battery pack includes an enclosure, a plurality of battery modules positioned in the enclosure, where each battery module may include a plurality of battery cells, a venting system positioned in the enclosure between a first set of battery modules of the plurality of battery modules and a second set of battery modules of the plurality of battery modules. The venting system includes a divider, the divider defines a first vent volume within the venting system and a second vent volume within the venting system that is fluidly isolated from the first vent volume, the first set of battery modules is in fluid communication with an exterior of the battery pack through the first vent volume and the second set of battery modules is in fluid communication with the exterior of the battery pack through the second vent volume, the venting system is coupled to a surface of the enclosure, and the venting system provides support to, and increases a rigidity of, the battery pack.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, according to at least one example.

FIG. 1B illustrates an exploded, isometric view of the battery pack of FIG. 1A, according to at least one example.

FIG. 2A illustrates a first isometric view of a venting system, according to at least one example.

FIG. 2B illustrates a second isometric view of the venting system of FIG. 2A, according to at least one example.

FIG. 3 illustrates an isometric view of a panel, according to at least one example.

FIG. 4 illustrates a cross-sectional view of the battery pack of FIG. 1A along Section A-A, according to at least one example.

FIG. 5 illustrates a magnified view of a section of the cross-sectional view of the battery pack of FIG. 1A along Section A-A, according to at least one example.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Rechargeable battery packs used in electric vehicles (e.g., traction batteries) can account for thermal runaway events by venting effluent discharge (e.g., byproducts of thermal runaway event, such as gases, fluids, smoke, flames, or the like) from an interior of the battery pack to exterior of the battery pack. In some conventional battery packs, the battery pack may include a venting system to vent effluent discharge for the whole pack such that a thermal runaway event for any battery in the battery pack is vented along a same vent volume. While using only a single venting system with a single vent volume for all the batteries may minimize the weight of the battery pack, such a venting system means that a thermal runaway event for one battery may affect the other batteries of the battery pack (e.g., increase the temperatures of those other batteries) such that those other batteries also undergo a thermal runaway event. This cascading chain of thermal runaway events can result in the entire battery pack to fail. While this result may be somewhat acceptable in certain electric vehicles, such as in electric cars, where the venting system is designed only to prevent the thermal runaway event from affecting the other portions of the electric vehicle, the total failure of the battery pack is unacceptable in other electric vehicles, such as aeronautical vehicles, where a total failure of the battery pack can have more dangerous results (e.g., the electric vehicle crashing from a large height).

Other conventional battery packs can address this issue by providing a venting system for each battery so that a thermal runaway event of one battery will not affect other batteries in the battery pack. In particular, a venting system can be fluidly coupled to the battery modules housing each battery. However, given the large number of batteries used in battery packs, all these venting systems can, cumulatively, add a large amount of weight to the battery pack. This increased weight can be an issue where the battery pack is installed in electric vehicles that are particularly sensitive to weight, such as aeronautical vehicles. Further, in such conventional battery packs, each battery module is separately mounted to the battery pack with mounting structures (e.g., brackets) that secure the battery module to the mounting frame, and that provide structural support between the battery modules and the mounting frame. These separate mounting structures, cumulatively, can also add a large amount of weight to the battery pack, thus further exacerbating the above-noted weight issue.

The present disclosure addresses these issues by providing a battery pack that can provide both thermal management and load-bearing properties while also fluidly isolating at least some batteries from other batteries. In particular, the battery pack may include a venting system positioned between rows of battery modules. The venting system may define separate, fluidly isolated, vent volumes for each of the rows of battery modules such that, should any of the batteries in either row of battery modules undergo a thermal runaway event, the batteries of the other row would not be affected by that thermal runaway event. Additionally, the venting system may be coupled to the one or more components of the surrounding enclosure of the battery pack such that the venting system provides structural support to the battery pack in addition to thermal management. As such, the battery pack of the present disclosure can provide a vent volume for effluent discharge that does not affect all the other batteries of the battery pack while also decreasing the amount of components required to provide thermal management and load-bearing to the battery pack. Further, the battery modules may also be coupled to the surrounding enclosure of the battery pack to provide structural support to the battery pack, thus also decreasing the amount of components used in the battery pack. In this manner, the battery pack of the present disclosure can provide a more lightweight and structurally efficient battery pack than conventional battery packs.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, heavy machinery, transportation equipment, aeronautical and/or spacecraft electronics payloads, vehicles, as well as any other device that may use battery cells or benefit from the discussed designs. Accordingly, the disclosure and claims are not to be considered limited to any particular example discussed but can be utilized broadly with any number of devices that may exhibit some or all of the electrical or chemical characteristics of the discussed examples.

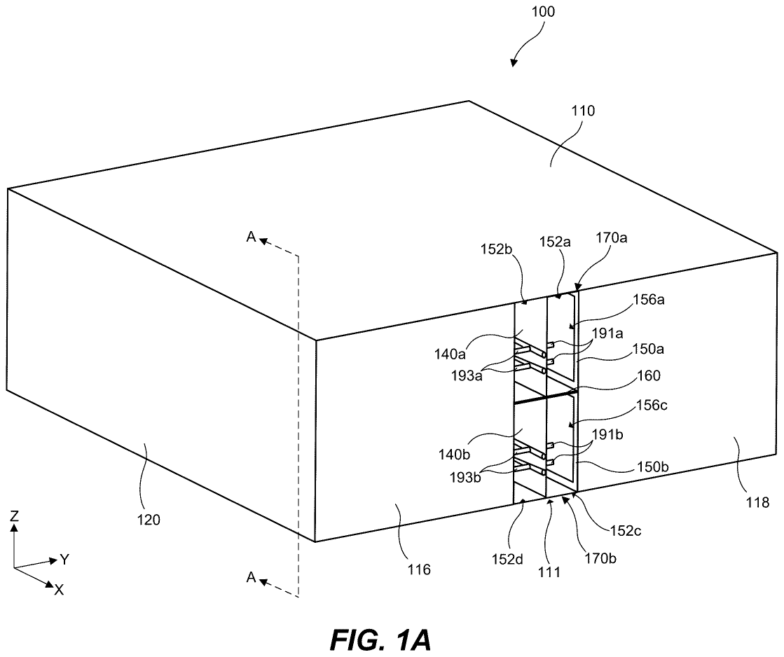

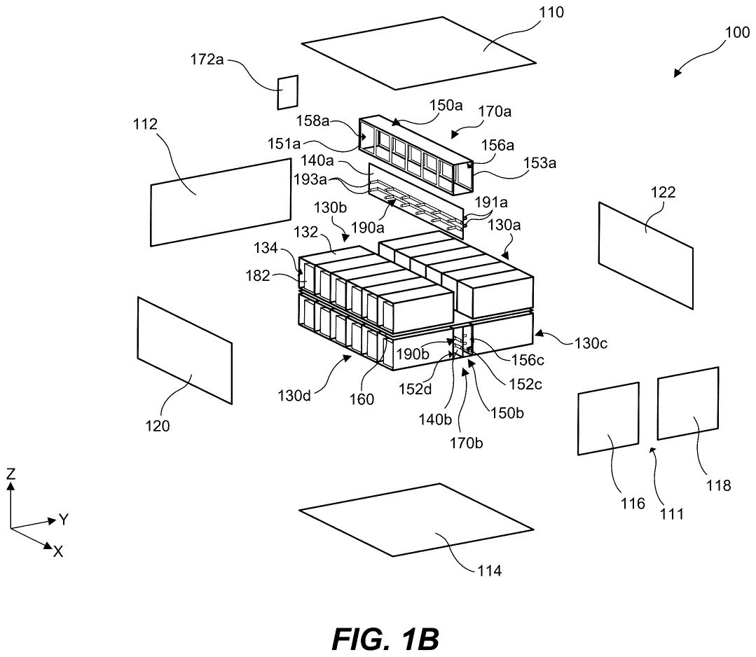

FIGS. 1A and 1B depict an example battery pack 100. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells such that each module row 130a, 130b, 130c, 130d. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

As noted above, certain conventional battery packs have issues with minimizing the risk of cascading thermal runaway events that affect all the batteries in the battery pack. Other conventional battery packs solve this issue by providing a venting system for each battery module of the battery pack. However, providing so many vent systems is inefficient and increases the weight of the battery pack. This weight can cause issues when the battery pack is installed in certain electric vehicles, such as aeronautical vehicles, that can have their performance reduced due to the increased weight.

The venting systems 170a, venting system 170b positioned in the interior volume of the battery pack 100 addresses this issue. The first venting system 170a is fluidly coupled along a first side of the platform 160 (e.g., a first surface) between the first module row 130a and the second module row 130b. The second venting system 170b is coupled along a second side of the platform 160 (e.g., a second surface), opposite the first surface of the platform 160, between the third module row 130c and the fourth module row 130d.

The first venting system 170a can include a first venting structure 150a housing a first divider 140a. The second venting system 170b can include a second venting structure 150b housing a second divider 140b. The dividers 140a, 140b can be coupled to the corresponding venting structure 150a, 150b through welding, brazing, soldering, gluing, fastening, or the like. In some embodiments, the dividers 140a, 140b may be centrally positioned in the corresponding venting structure 150a, 150b along the Y-axis to evenly divide different sections of the corresponding venting systems 170a, 170b. However, in other embodiments, the dividers may be positioned in the corresponding vent system along the Y-axis closer to one of the ends of the vent system.

The dividers 140a, 140b can be coupled within the venting structures 150a, 150b to define vent volumes within the venting systems 170a, 170b that are fluidly isolated from each other. For example, as shown more clearly in FIG. 1A, the first divider 140a can define, with the first venting structure 150a, a first vent volume 152a and a second vent volume 152b within the first venting system 170a. The second divider 140b can define, with the second venting structure 150b, a third vent volume 152c and a fourth vent volume 152d within the second venting system 170b. The dividers 140a, 140b can be coupled to the corresponding venting structures 150a, 150b such that fluid cannot escape from one vent volume 152a, 152c to the other vent volume 152b, 152d while the fluid remains within the corresponding venting system 170a, 170b. In this manner, the vent volumes 152a, 152b are fluidly isolated from each other within the first venting system 170a and the vent volumes 152c, 152d are fluidly isolated from each other within the second venting system 170b. The vent volumes 152a, 152b, and the vent volumes 152c, 152d, can each have a substantially equal volume (e.g., volumes within about a 20% deviation of each other, such as about a 10% deviation, such as about a 5% deviation, or being completely the same) where the
dividers 140a, 140b are coupled to a central point along a width of the venting structures 150a, 150b along the Y-axis. However, in other embodiments, where one or more of the dividers is positioned closer to one end of the venting structure than the other, the vent volumes may have correspondingly different volumes within the venting structure.

The venting systems 170a, 170b can be fluidly coupled to each battery module 132 of the module rows 130a, 130b, 130c, 130d through vent openings defined in the venting structure 150a, 150b for each of the battery modules 132. For example, the first venting structure 150a may define first vent openings 156a that allows for fluid communication between each battery module 132 of the first module row 130a with the first vent volume 152a and second vent openings 158a that allows for fluid communication between each battery module 132 of the second module row 130b with the second vent volume 152b. The second venting structure 150b may define vent openings similar to the first venting structure 150a, such as third vent openings 156b for the third module row 130c and fourth vent openings (not shown in FIGS. 1A and 1B) for the fourth module row 130d. The venting structures 150a, 150b can define as many vent openings 156a, 158a, 156c as there are battery modules 132 of the corresponding module rows 130a, 130b, 130c, 130d. However, in other embodiments, the venting structures can more or less vent openings than there are battery modules of the corresponding module rows.

Although FIGS. 1A and 1B depict two venting systems 170a, 170b, in other embodiments, there may be more or less than two venting systems. For example, each module row can include a corresponding venting system. In this example, the adjacent venting structures can individually define vent volumes for each of the module row. The walls of the adjacent venting structures can be coupled together to, collectively, define a divider, similar to the divider described above.

The panels 116, 118 may define, therebetween, an exit opening 111 to allow for the vent volumes 152a, 152b, 152c, 152d to fluidly communicate with an exterior (e.g., the external environment outside of the battery pack 100) of the battery pack 100 (e.g., to allow for effluent discharge to escape the vent volumes 152a, 152b, 152c, 152d to exterior of the battery pack 100). However, in other embodiments, the fourth and fifth panels may not define an opening therebetween. In this example, the effluent discharge may escape to exterior of the battery pack through a different portion of the battery pack other than the vent opening, such as through one or both of the sidewalls. In another example, the fourth and fifth panels may be coupled together or may form a monolithic structure such that the exit opening may be an opening defined along that single structure.

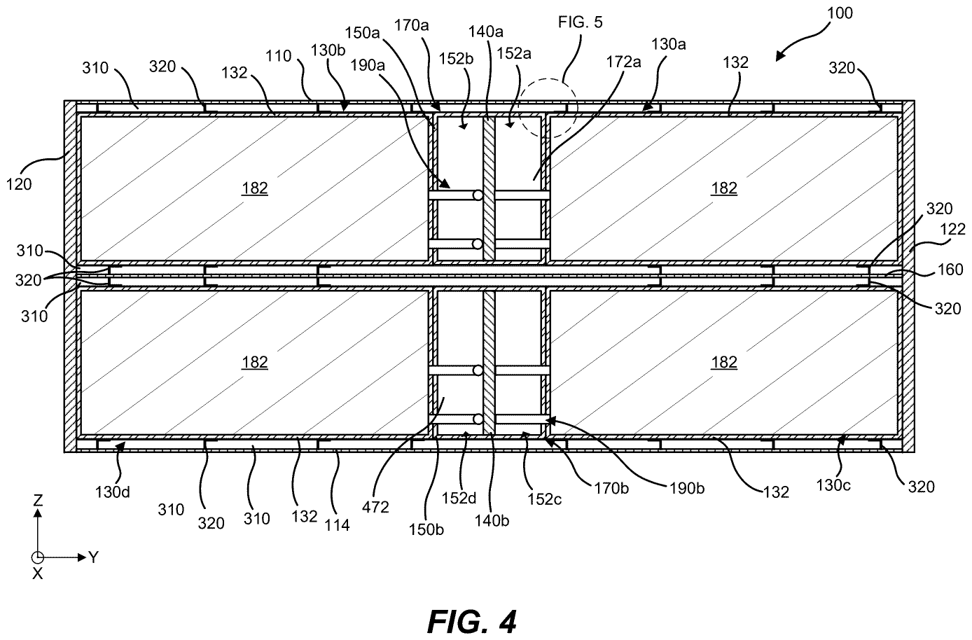

The venting systems 170a, 170b can include a wall that helps funnel effluent discharge from the battery modules 132 toward the exit opening 111 and into the environment outside of the battery pack 100. For example, with specific reference to the first venting system 170a as shown in FIG. 1B, the first venting system 170a can include a first wall 172a coupled to a first end 151a of the first venting structure 150a. The first wall 172a can prevent effluent discharge from escaping the first venting structure 150a from the first end 151a such that any effluent discharge from the battery modules 132 in the module rows 130a, 130b flow in the corresponding vent volumes 152a, 152b toward a second end 153a of the first venting structure 150a to escape into the exit opening 111. Although not shown in FIGS. 1A and 1B, the second venting system 170b can include a second wall (e.g., second wall 472, as shown in FIG. 4) coupled to a corresponding end of the second venting structure 150b such that the effluent discharge from the battery modules 132 of the module rows 130c, 130d similarly flows out of the vent volumes 152c, 152d to the exit opening 111.

The battery pack 100 can include coolant manifolds coupled (e.g., via welding, brazing, soldering, gluing, fastening, or the like) to the dividers 140a, 140b to flow coolant with the battery modules 132 of the module rows 130a, 130b, 130c, 130. For example, a first coolant manifold 190a can be coupled to the first divider 140a. The first coolant manifold 190a can include one or more pipes coupled together (e.g., via welding, brazing, soldering, gluing, fastening, or the like) for coolant to flow through. The first coolant manifold 190a can include a first coolant port set 191a extending along the Y-axis from the first divider 140a, through the corresponding first vent opening 156a, and toward the first module row 130a to fluidly couple with a corresponding battery module 132 of the first module row 130a. The first coolant manifold 190a can include a second coolant port set 193a extending along the Y-axis from the first divider 140a, past the corresponding second vent opening 158a, toward the second module row 130b to fluidly couple with a corresponding battery module 132 of the second module row 130b. The first coolant manifold 190a can include as many coolant port sets 191a, 193a as there are battery modules 132 of the corresponding module rows 130a, 130b. A second coolant manifold 190b can be coupled to the second divider 140b including a similar structure to the first coolant manifold 190a (e.g., a third coolant port set 191b similar to the first coolant port set 191a, a fourth coolant port set 193b similar to the second coolant part set 193a, or the like) and may provide a similar function to the battery modules 132 of the module rows 130c, 130d.

The first and second coolant manifolds 190a, 190b can fluidly couple with a coolant source such that a coolant can be flowed between the battery modules 132 of the module rows 130a, 130b, 130c, 130d and the coolant source through the coolant manifolds 190a, 190b and coolant port sets 191a, 191b, 193a, 193b. Each coolant port set 191a, 191b, 193a, 193b can include an inlet port and an outlet port. For example, a top port along the Z-axis of each coolant port set 191a, 191b, 193a, 193b can be an inlet port and a bottom port along the Z-axis of each coolant port set 191a, 191b, 193a, 193b can be an outlet port. In an alternative embodiment, the bottom port of each coolant port set can be an inlet port and a top port of each coolant port set can be an outlet port. In this manner, the inlet port of each coolant port set 191a, 191b, 193a, 193b can flow coolant from the coolant source into the corresponding battery modules 132 and the outlet port can flow coolant out of the corresponding battery modules 132 (e.g., to a cooling component that cools the component before being recirculated back to the coolant source).

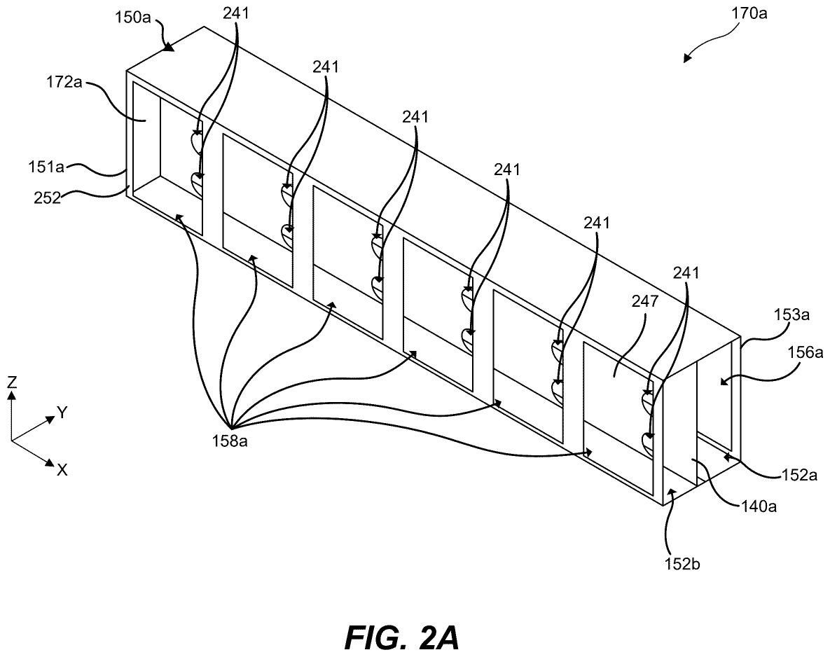

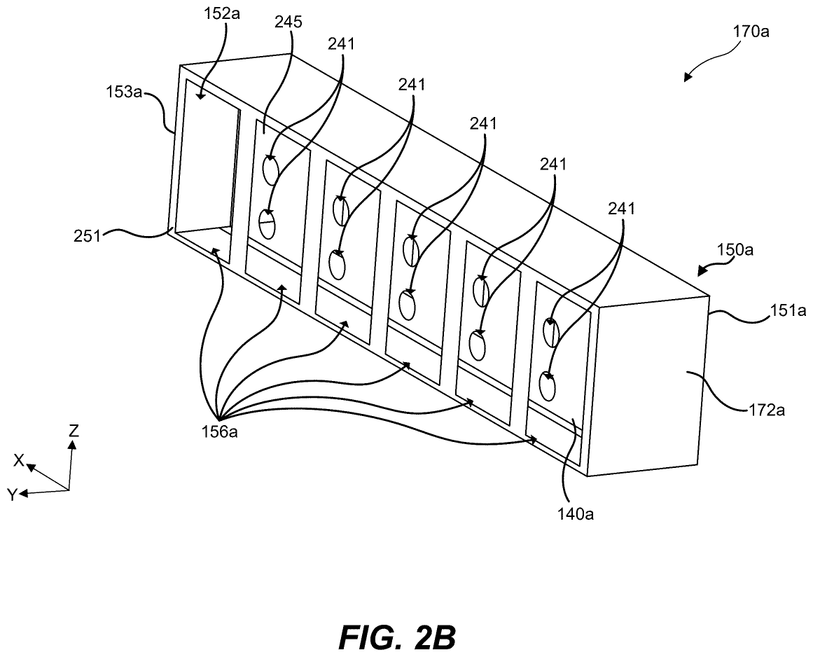

FIGS. 2A and 2B depict a more detailed view of the first venting system 170a. Although the following description will be directed to the first venting system 170a, it is understood that the second venting system 170b is similar to the first venting system 170a unless noted otherwise.

The first venting structure 150a can include a first side surface 251 defining the first vent openings 156a and a second side surface 253 defining the second vent openings 158a. The first module row 130a can be coupled against the first side surface 251 (e.g., via welding, brazing, soldering, gluing, fastening, or the like) such that each battery module 132 of the first module row 130a is in fluid communication with the first vent volume 152a through the corresponding first vent opening 156a. The second module row 130b can be coupled against the second side surface 253 (e.g., via welding, brazing, soldering, gluing, fastening, or the like) such that each battery module 132 of the second module row 130b is in fluid communication with the second vent volume 152b through the corresponding second vent opening 158a. Although the side surfaces 251, 253 are depicted as defining individual vent openings 156a, 158a, in other embodiments, each of the side surfaces may define a single vent opening for the entire module row. For example, this vent opening may extend from adjacent the first end of the first venting structure to adjacent the second end. This may be beneficial to minimize the weight of the first venting structure.

The first divider 140a can include a first side 245 and a second side 245 (e.g., as shown in FIG. 2B). The first coolant manifold 190a can be coupled against the first side 245, as shown in FIGS. 1A and 1B, however, in other embodiments, the first coolant manifold can be coupled against the second side. The first divider 140a can define aperture sets 241 along a length of the first divider 140a for each pair of coolant port sets 191a, 193a to extend through. Although the aperture sets 241 are depicted as including a corresponding aperture for each coolant port of the coolant port sets 191a, 193a, in other embodiments, the first divider may define a single aperture sized and shaped to receive both coolant ports of each coolant port set.

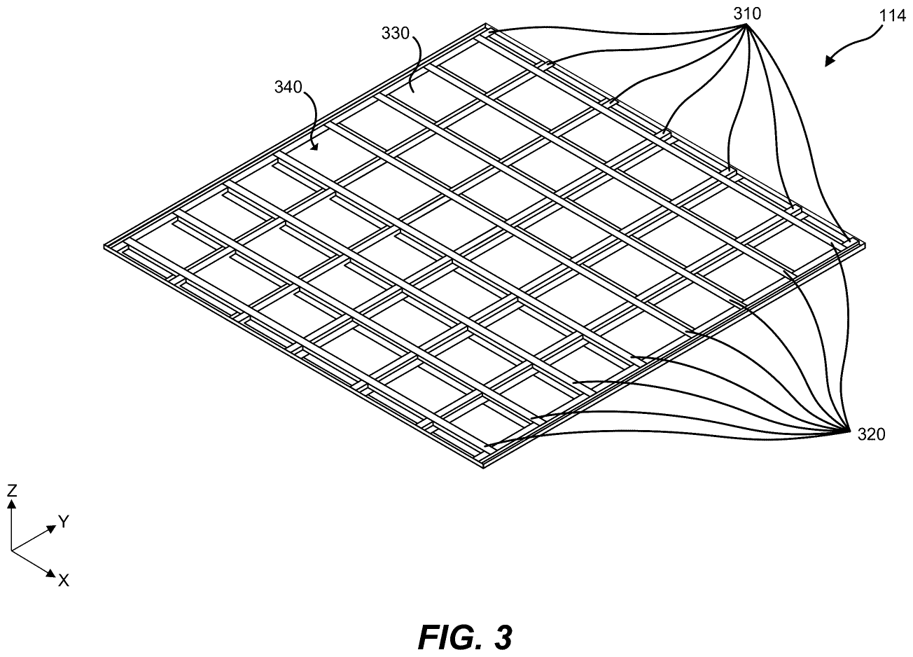

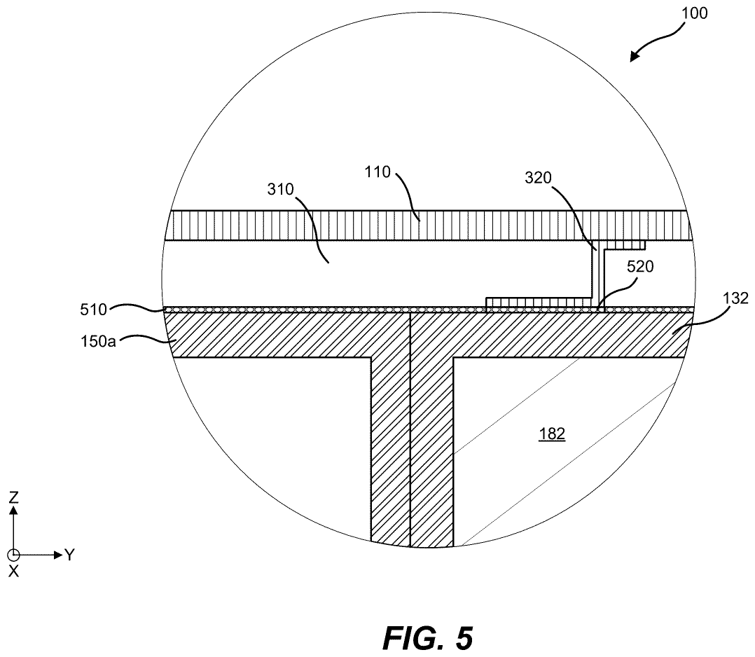

FIG. 3 depicts a more detailed view of the third panel 114. As noted below, although the following description is directed to the third panel 114, it is understood that the other panels 110, 112, 116, 118 and the platform 160 can include similar features. In particular the third panel 114 can include a set of first ribs 310 and a set of second ribs 320 extending from a base 330 along a Z-axis. The ribs 310, 320 can extend along the Z-axis in a direction toward the interior volume of the battery pack 100 when the third panel 114 is assembled in the battery pack 100. The ribs 310, 320 can extend from the base 330 having an L-shape (as shown more clearly in FIGS. 4 and 5), however, in other embodiments, the ribs can extend from the base with other geometric shapes, such as having a cuboid shape, a T-shape, or the like.

The first ribs 310, the second ribs 320, and the base 330 can define, therebetween, pockets 340. The air in the pockets 340 can provide insulation to batteries 132 positioned over the pocket 340. For example, at least some portion of the battery modules 132 can be exposed to the pockets 340 so that the air in those pockets 340 can provide insulation to the battery modules 132 positioned on the third panel 114. In this example, there may be no intervening component between the battery modules 132 and the pocket 340 to maximize the amount of insulation that the air in the pocket 340 provides to the battery module 132. However, in other embodiments, there may be one or more intervening components positioned between the battery module and the pocket. Further, the ribs 310, 320 can increase the load-bearing capabilities of the panels 110, 112, 116, 118 and the platform 160 (e.g., increase the amount of weight that the panels 110, 112, 116, 118 and the platform 160 can support from components positioned on the ribs 310, 320) compared to without the ribs 310, 320. However, in other embodiments, the third panel may not include ribs to further minimize the weight of the battery pack.

The first ribs 310 can define a same number of rows of pockets 340 extending in a Y-axis as there are battery modules 132 in each of the module rows 130c, 130d (e.g., six pockets 340 for six battery modules 132 in each of the module rows 130c, 130d). In this manner, when assembled, each of the battery modules 132 of the module rows 130c, 130d can be positioned on the second ribs 320 over their own pockets 340 along a corresponding row of pockets 340 defined between the first ribs 310. In this example, each battery module 132 of a module row 130c, 130d may not share a pocket 340 with an adjacent battery module 132 in the same module row 130c, 130d. In other words, each battery module 132 may include their own exclusive pocket(s) 340 along the row of pockets 340 extending in a Y-axis. However, in some embodiments, each battery module 132 may be positioned over more than one pocket 340 in the row of pockets 340 (e.g., over two pockets 340, three pockets 340, or the like) that extends in the X-axis (e.g., the pockets 340 defined between the second ribs 320). In other embodiments, each battery module may also be positioned over only one pocket of the row of pockets extending along the X-axis.

Such a configuration allows for each battery module 132 in a given module row 130c, 130d to have their own pocket 340 for insulation and to assist in thermally isolating each battery module 132 from another, even within the same module row 130c, 130d. However, in other embodiments, there can be more or less pockets than there are battery modules in each module row. In some embodiments, the battery modules 132 of the module rows 130c, 130d can be positioned over the pockets 340 along the second ribs 320 without being positioned on the first ribs 310. However, in other embodiments, these batteries can be additionally positioned on one or both of the adjacent first ribs of the pocket.

The first ribs 310 can extend on the base 330 along a Y-axis and the second ribs 320 can extend on the base 330 along an X-axis such that the ribs 310, 320 are oriented to the base 330 in a substantially perpendicular direction to each other. In this manner, each of the pockets 340 can have a substantially similar size and can hold a similar amount of air. The similarity in air of each pocket 340 can provide a similar amount of insulation between any of the battery modules 132 positioned on the third panel 114 regardless of the position of the battery modules 132 on the third panel 114, thus minimizing a temperature gradient of the batteries 132 positioned on the third panel 114. However, in other embodiments, one or more of the ribs can be positioned relative to each other at an angle such that the pockets defined between the ribs have different sizes along the third panel. Although each of the ribs 310, 320 are depicted as being substantially equally spaced from each other, thus also contributing to pockets 340 having a substantially similar size, in other embodiments, one or more of the ribs can have different spacing from each other.

As noted above, the panels 110, 112, 116, 118 can include similar features as the third panel 114. For example, the panels 110, 112, 116, 118 can each include their own ribs 310, 320 extending from a corresponding base 330 that, collectively, can define their own pockets 340. In one particular example, the first panel 110 can have a same configuration of ribs 310, 320 and pockets 340 as the third panel 114 except with the ribs 310, 320 of the first panel 110 facing in an opposite direction along the Z-axis as the ribs 310, 320 of the third panel 114. One or more of the panels 110, 112, 114, 116, 118 can have a similar size as each other. For example, the panels 110, 114 can have a substantially similar size and the panels 116, 118 can have a substantially similar. However, the panels 110, 112, 114, 116, 118 can have a different size other than those similarities.

The platform 160 can include similar ribs 310, 320 and pockets 340 as the panels 110, 112, 114, 116, 118. However, the ribs 310, 320 and pockets 340 of the platform 160 can extend from each side of the platform 160 along the Z-axis rather than only on a single side, as in the panels 110, 112, 114, 116, 118. In this manner, the platform 160 can define pockets 340 to insulate the battery modules 132 that are coupled to each side of the platform 160. The platform 160 and panels 110, 112, 114, 116, 118 can each include a substantially similar orientation of ribs 310, 320, however, in other embodiments, one or more of the platforms and/or panels can include ribs and pockets having a different orientation than the other platform and/or panels.

In some embodiments the ribs 310, 320 can be formed separately from the panels 110, 112, 116, 118 and platform 160 (e.g., through stamping, computer numerical control, or the like), and then coupled to the corresponding panels 110, 112, 116, 118 and platform 160 (e.g., via welding, brazing, soldering, gluing, fastening, or the like). However, in other embodiments, one or more of the ribs can be monolithically formed with one or more of the panels and/or the platform.

As noted above, the venting systems 170a, 170b can provide thermal management capabilities and load-bearing capabilities. For example, turning back to FIGS. 1A and 1B, the vent volumes 152a, 152b, 152c, 152d of the venting systems 170a, 170b are in fluid communication with an exterior of the battery pack 100 through the exit opening 111 so that any groupings 182 of battery cells undergoing a thermal runaway event can vent the effluent discharge from that grouping 182 of battery cells, through the corresponding battery module 132 (e.g., through a containment mechanism in the battery module 132, such as a rupture disk or the like) to exterior of the battery pack 100 through the corresponding vent volume 152a, 152b, 152c, 152d. At the same time the vent volumes 152a, 152b, 152c, 152d are fluidly isolated from each other so that the thermal runaway event of one or more groupings 182 of battery cells in one module row 130a, 130b, 130c, 130d do not affect the other groupings 182 of battery cells in the other module row 130a, 130b, 130c, 130d (or other components of the battery pack 100). This is especially important to minimize the risk that all groupings 182 of battery cells in the battery pack 100 fail due to cascading thermal runaway events while also reducing the number of components required to perform this function. In addition, as described below, the venting systems 170a, 170b also provides load-bearing capabilities to the battery pack 100, thus further reducing the number of components (and, therefore weight) required to perform the same functions in conventional battery packs.

FIG. 4 depicts a cross-sectional view of the battery pack 100 along Section A-A, as shown in FIG. 1A. The first venting system 170a may be coupled between the first ribs 310 extending from the first panel 110 in a downward direction along the Z-axis (e.g., in a direction toward the first venting system 170a) and the first ribs 310 extending from the platform 160 in an upward direction along the Z-axis (e.g., in a direction toward the first venting system 170a). The second venting system 170b may be coupled between the first ribs 310 extending from the third panel 114 in an upward direction along the Z-axis (e.g., in a direction toward the second venting system 170b) and the first ribs 310 extending from the platform 160 in a downward direction along the Z-axis (e.g., in a direction toward the second venting system 170b). In some embodiments, one or more of the venting systems may be additionally or alternatively coupled between the second ribs that extend from at least one of the panels.

As the venting systems 170a, 170b can be made of rigid materials, as discussed below, the venting systems 170a, 170b can act as structural supports between the panels 110, 114 and the platform 160 that provides support to, and increases the rigidity of, the battery pack 100. Additionally, the venting systems 170a, 170b can extend along substantially an entire length of the battery pack 100 along the X-direction (e.g., within about a 20% deviation of a total length of the battery pack 100 along the X-direction, such as about a 10% deviation, such as about a 5% deviation, or being completely the same as the total length of the battery pack 100) to thereby increase a rigidity of the battery pack 100. In this manner, the venting systems 170a, 170b can provide the dual-purpose of a thermal management system for venting effluent discharge for thermal runaway events without affecting all groupings 182 of battery cells in the battery pack 100 while also providing structural support to the battery pack 100. Accordingly, compared to conventional battery packs, the venting systems 170a, 170b leads not only to requiring fewer venting components in the battery pack 100 to vent effluent discharge in a manner that does not affect all groupings 182 of battery cells, less load-bearing components are required to provide structural support to the battery pack 100. This decrease in components can minimize the weight of the battery pack 100 which, in turn, can improve the performance of the electric device that the battery pack 100 is mounted to (e.g., an aeronautical electric vehicle).

Additionally, at least one or more of the battery modules 132 can similarly provide structural support to the battery pack 100. For example, each battery module 132 can also be coupled between the ribs 310, 310 of the panels 110, 114 and the platform 160, and can be made of a rigid material, such that the battery modules 132 can act as a structural support between the panels 110, 114 and the platform 160. In some embodiments, one or more of the battery modules 132 can include a surface that is coupled to both the first and second ribs 310, 320 extending from the panels 110, 114 and the platform 160 (e.g., where a battery module 132 is positioned on an intersection between the ribs 310, 320). In this manner, the battery modules 132 can also provide support to, and increases the rigidity of, the battery pack 100. As the battery modules 132 provide this structural support, the battery pack 100 can require less load-bearing components compared to conventional battery packs. In turn, this can decrease the weight of the battery pack 100 and improve the performance of the electric device that the battery pack 100 is mounted to.

FIG. 5 depicts a magnified view of the battery pack 100 including a first coupling component 510 coupling the first venting structure 150a to the first rib 310 of the and a second coupling component 520 coupling the battery module 132 to the second rib 320. Although FIG. 5 depicts only the first venting structure 150a and the illustrated battery module 132 as being coupled to the ribs 310, 320 of the first panel 110 with the coupling components 510, 520, it should be understood that corresponding coupling components 510, 520 can couple the other battery modules 132 and the second venting structure 150b to the other ribs 310, 320 extending from the other panels 112, 114, 116, 118 and the platform 160. In particular, the first coupling component 510 can be positioned on the first rib 310 to couple the battery modules 132 and venting structures 150a, 150b to the first rib 310, and the second coupling component 520 can be positioned on the second rib 320 to couple the battery modules 132 and venting structures 150a, 150b to the second rib 320.

The coupling components 510, 520 can be, or include, an adhesive material that adheres the first venting structure 150a and the battery module 132 to the ribs 310, 320. In some examples, one or more of the coupling components 510, 520 can include a tape (e.g., a double-sided adhesive tape), paste, gel, or the like. The coupling components 510, 520 can include a thermally insulating adhesive that also provides thermal insulation between the ribs 310, 320, and battery modules 132 and venting structures 150a, 150b to further thermally isolate the battery modules 132 from each other. In one particular example, one or more of the coupling components 510, 520 can include an aerogel tape.

The sidewalls 120 122, panels 112, 114, 116, 118, battery modules 132, dividers 140a, 140b, first wall 172a, and venting structures 150a, 150b may be made of, or include, a metal, plastic, or the like. For example, the battery modules 132, dividers 140a, 140b, first wall 172a, and venting structures 150a, 150b may include a metal (e.g., titanium, aluminum, steel, or the like). These components can be formed from one or more components through welding (e.g., laser welding or the like), brazing, soldering, gluing, fastening, or the like. However, in other embodiments, one or more of these components can be formed as a monolithic (e.g., extruded or the like) piece.

The panels 112, 114, 116, 118 can be made of, or include, a material that provides structural integrity to the battery pack 100 while being able to withstand high temperatures (e.g., about 1200° C. or the like) without the panels 112, 114, 116, 118 losing their own structural integrity. For example, the panels 112, 114, 116, 118 can be made of a composite material having a high temperature resistance, such as plastic material (e.g., a polymer material or the like). One example polymer material may include, for example, a polymer composite, such as a low-melt polyarylatetherketone. Battery packs 100 including panels 112, 114, 116, 118 made of low-melt polyarylatetherketone can provide an improved structural integrity, high temperature resistance, and decreased overall weight compared to conventional battery packs. However, in other embodiments, the panels may be made of other materials, such as metals (e.g., titanium, aluminum, or the like) or the like. For example, the panels may be made of, or include, a carbon fiber material to form a carbon fiber composite.

The sidewalls 120, 122 may be coupled to the panels 112, 114, 116, 118 such that the sidewalls 120, 122 cover the battery volumes 134. This can be beneficial to further minimize the number of components in the battery pack 100 (and, therefore, the weight of the battery pack 100) by covering all the battery volumes 134 for the corresponding module rows 130a, 130b, 130c, 130d with a sidewall 120, 122, rather than separate components (e.g., separate caps), as in conventional battery packs. However, in other embodiments, one or more components may be positioned between the sidewall 120, 122 and the battery volume 134 (e.g., a module cap or the like). The sidewalls 120, 122 may include components and/or features that can allow battery cells positioned in the battery modules 130 to electrically communicate with other components outside of the battery pack 100. For example, the sidewalls 120, 122 may include channels or openings for wires, cables, or the like to extend from exterior of the battery pack 100 into the internal volume of the pack 100. However, in other embodiments, the sidewalls may not have such components or features, and may simply enclose the battery volume.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A battery pack comprising:
an enclosure defining an internal volume;
a plurality of rows of battery modules positioned in the internal volume, wherein each battery module comprises a plurality of battery cells; and
a venting system positioned in the internal volume between a first row of battery modules of the plurality of rows of battery modules and a second row of battery modules of the plurality of rows of battery modules, wherein:
the venting system is fluidly coupled to the first row of battery modules and defines a first vent volume from each battery module of the first row of battery modules to exterior of the battery pack;
the venting system is fluidly coupled to the second row of battery modules and defines a second vent volume from each battery module of the second row of battery modules to exterior of the battery pack;
the first vent volume is fluidly isolated from the second vent volume;
the venting system is coupled to a surface of the enclosure; and
the venting system extends along substantially an entire length of the battery pack, thereby increasing a rigidity of the battery pack.

2. The battery pack of claim 1, wherein the venting system includes a divider that partially defines the first vent volume on a first surface of the divider and the second vent volume on a second surface of the divider.

3. The battery pack of claim 2, wherein the divider includes a coolant manifold fluidly coupled to each battery module of the first row of battery modules and the second row of battery modules.

4. The battery pack of claim 1,
wherein the venting system is a first venting system; and
the battery pack further comprises:
a platform including a first side and a second side opposite the first side, wherein the first venting system, the first row of battery modules, and the second row of battery modules are coupled to the first side of the platform; and
a second venting system, a third row of battery modules of the plurality of rows of battery modules, and a fourth row of battery modules of the plurality of rows of battery modules are coupled to the second side of the platform, wherein the second venting system is positioned between the third row of battery modules and the fourth row of battery modules.

5. The battery pack of claim 4, wherein:
the second venting system is fluidly coupled to the third row of battery modules and defines a third vent volume from each battery module of the third row of battery modules to exterior of the battery pack;
the second venting system is fluidly coupled to the fourth row of battery modules and defines a fourth vent volume from each battery module of the fourth row of battery modules to exterior of the battery pack; and
the third vent volume is fluidly isolated from the fourth vent volume.

6. The battery pack of claim 5, wherein:
the surface of the enclosure is a first surface of the enclosure;
the first venting system is coupled between the first surface and the first side of the platform to provide structural support between the first surface and the platform; and
the second venting system is coupled between a second surface of the enclosure and a second side of the platform to provide structural support between the second surface and the platform.

7. The battery pack of claim 5, wherein:
the enclosure defines an exit opening to exterior of the battery pack; and
the first vent volume, the second vent volume, the third vent volume, and the fourth vent volume are in fluid communication with the exit opening.

8. The battery pack of claim 1, further comprising a plurality of panels at least partially defining the enclosure, wherein:
the surface of the enclosure is a first surface of a first panel of the plurality of panels; and
the venting system is coupled to the first panel to provide support to, and increases the rigidity of, the battery pack.

9. The battery pack of claim 8, wherein:
each panel of the plurality of panels includes a plurality of ribs extending in the internal volume;
the first surface of the first panel includes a rib surface of a first rib of the plurality of ribs; and
the venting system is coupled to the first rib to provide support to, and increases the rigidity of, the battery pack.

10. The battery pack of claim 9, wherein:
adjacent ribs of the plurality of ribs defines a pocket therebetween; and
each battery module of the first row of battery modules and each battery module of the second row of battery modules is positioned at least partially over a corresponding pocket.

11. The battery pack of claim 10, wherein the corresponding pocket that each battery module of the first row of battery modules and each battery module of the second row of battery modules is positioned over is exclusive to each battery module.

12. The battery pack of claim 8, wherein at least one panel of the plurality of panels includes a carbon fiber material.

13. The battery pack of claim 8, further comprising a thermally insulating adhesive adhering the venting system to the first panel.

14. The battery pack of claim 1, wherein each battery module of the first row of battery modules and each battery module of the second row of battery modules is coupled to the surface of the enclosure such that each battery module of the first row of battery modules and each battery module of the second row of battery modules provides support to, and increases the rigidity of, the battery pack.

15. The battery pack of claim 1, wherein:
a first battery module of the first row of battery modules exhausts a first effluent discharge from the first battery module, through the first vent volume, to exterior of the battery pack; and
the first effluent discharge within the first vent volume is fluidly isolated from the second vent volume.

16. A battery pack comprising:
an enclosure defining an exit opening exposing the battery pack to an environment outside of the battery pack;
a plurality of rows of battery modules positioned in the enclosure, wherein each battery module comprises a plurality of battery cells; and
a venting system positioned in the enclosure between a first row of battery modules of the plurality of rows of battery modules and a second row of battery modules of the plurality of rows of battery modules, wherein:
the venting system is fluidly coupled to the first row of battery modules and defines a first vent volume from each battery module of the first row of battery modules to the exit opening;
the venting system is fluidly coupled to the second row of battery modules and defines a second vent volume from each battery module of the second row of battery modules to the exit opening;
the first vent volume is fluidly isolated from the second vent volume;
the venting system is coupled to the enclosure; and
the venting system extends along substantially an entire length of the battery pack, thereby increasing a rigidity of the battery pack.

17. The battery pack of claim 16,
wherein the venting system is a first venting system; and
the battery pack further comprises:
a platform including a first side and a second side opposite the first side, wherein the first venting system, the first row of battery modules, and the second row of battery modules are coupled to the first side of the platform; and
a second venting system, a third row of battery modules of the plurality of rows of battery modules, and a fourth row of battery modules of the plurality of rows of battery modules are coupled to the second side of the platform, wherein the second venting system is positioned between the third row of battery modules and the fourth row of battery modules.

18. The battery pack of claim 17, wherein:
the second venting system is fluidly coupled to the third row of battery modules and defines a third vent volume from each battery module of the third row of battery modules to the exit opening;
the second venting system is fluidly coupled to the fourth row of battery modules and defines a fourth vent volume from each battery module of the fourth row of battery modules to the exit opening; and
the third vent volume is fluidly isolated from the fourth vent volume.

19. The battery pack of claim 18, further comprising a plurality of panels at least partially defining the enclosure, wherein the venting system is coupled to a first panel of the plurality of panels to provide support to, and increases the rigidity of, the battery pack.

20. A battery pack comprising:
an enclosure;
a plurality of battery modules positioned in the enclosure, wherein each battery module comprises a plurality of battery cells; and
a venting system positioned in the enclosure between a first set of battery modules of the plurality of battery modules and a second set of battery modules of the plurality of battery modules, wherein:
the venting system includes a divider;
the divider defines a first vent volume within the venting system and a second vent volume within the venting system that is fluidly isolated from the first vent volume;
the first set of battery modules is in fluid communication with an exterior of the battery pack through the first vent volume and the second set of battery modules is in fluid communication with the exterior of the battery pack through the second vent volume;
the venting system is coupled to a surface of the enclosure; and
the venting system extends along substantially an entire length of the battery pack, thereby increasing a rigidity of the battery pack.
